(19) United States
(12) Patent Application Publication
(10) Pub. No.: US 2026/0182602 A1
(43) Pub. Date: Jul. 2, 2026

(54) COVERED RETRACTED CONFECTIONERY

(71) Applicant: Imaginings 3, Inc., Niles, IL (US)

(72) Inventors: David Lisowski, Schaumburg, IL (US); Sidney Diamond, Barrington Hills, IL (US)

(73) Assignee: Imaginings 3, Inc., NIles, IL (US)

(21) Appl. No.: 19/419,043

(22) Filed: Dec. 14, 2025

Related U.S. Application Data
(60) Provisional application No. 63/740,119, filed on Dec. 30, 2024.

(51) Int. Cl. A23G 3/56

(52) U.S. Cl. CPC A23G 3/563

(57) ABSTRACT

A cover enclosing retracted confectionery includes an elongated housing with hinged covers adjacent the top for movement between closed and open positions with a central shaft, actuator having a plug received at the bottom portion of the housing and disposed along the central axis. In an embodiment, the plug is coupled at the bottom end of the central shaft for movement of the plug with the central shaft with respect to the housing. The plug incorporates a bias incorporated as a single unitary member and may define an opening both for locking engagement elements and advantageously allowing a lollipop confectionary to pass. In alternate embodiments the central shaft incorporates together as a single unitary member.

### FIELD OF THE INVENTION

This invention relates generally to novelty confectionery devices and more particularly to closed storage devices for confectioneries with efficient and reliable retracted confectionery design employing integrated componentry for improved manufacture and assembly with fewer separate parts.

### BACKGROUND OF THE INVENTION

Confectioneries, particularly hard candy such as lollipops, have long been popular. Efforts have been made in the prior art to enclose confectioneries such as lollipops which have not yet been consumed or are not fully consumed by the user as part of novelty items. For example, Klundt U.S. Pat. No. 6,763,681 issued Jul. 20, 2004, Silverstein et al. U.S. Pat. No. 6,136,352 issued Oct. 24, 2000, Coleman et al. U.S. Pat. No. 5,913,453 issued Jun. 22, 1999, Coleman et al. U.S. Pat. No. 5,531,318 issued Jul. 2, 1996, and U.S. Pat. No. 8,524,300 to Diamond and Lisowski issued Sep. 3, 2013. The closest prior art is Applicant's Assignee's U.S. Pat. No. 8,524,300 for “Covered retracted confectionery” issued Sep. 3, 2013 (herein incorporated by reference in its entirety) which utilizes a separate component spring coil bias positioned to be pushed into compression when its actuator moves the shaft from the retracted position to the extended position, while its spring coil bias is positioned to be pulled into compression when its actuator moves the shaft from the retracted position to the extended position.

The prior art apparatus structures have the disadvantage that their manufacture and assembly requires multiple separate parts. Accordingly, there remains a need for an efficient reliable retracted confectionery design with integrated componentry for improved manufacture and assembly. To address disadvantages of the prior art it would be further desirable to provide a single unitary central shaft with engagement elements receive a novel single unitary plug incorporating the bias where the plug end advantageously has a central opening or aperture for locking with the engagement elements for accommodating and allowing a lollipop to pass therethrough for use with the novel elongated housing.

### SUMMARY OF THE INVENTION

The present invention is concerned with providing a covered retracted confectionery including a housing having an interior and an exterior as well as a top and a bottom, covers hinged adjacent the top of the housing for movement between closed and open positions with an elongated housing having an exterior surface centrally defining an open interior with a central axis extending through the interior, the housing defining a top portion and a bottom portion at opposite ends of the central axis. A central shaft includes a top end and a bottom end correspondingly being disposed along the central axis of the housing, the central shaft mounted for movement between a retracted position and an extended position with respect to the housing. An actuator is used at the exterior surface of the housing for activation, and a pair of covers hinged at the top portion of the housing are in mechanical communication with the central shaft via activation of the actuator for movement of the central shaft with corresponding movement of the covers between a first closed position and a second open position. The confectionery receiving structure is disposed at the top end of the central shaft, the pair of covers for enclosing the confectionary with the covers in the first closed position and revealing the confectionary with the covers in the second open position. A plug and bias are received at the bottom portion of the housing and disposed along the central axis.

Briefly summarized the present inventions relate to covered retracted confectionery apparatus and methods in an elongated housing with a central shaft, actuator, hinged covers for enclosing the confectionary including a plug received at the bottom portion of the housing and disposed along the central axis, the plug being coupled at the bottom end of the central shaft for movement of the plug with the central shaft with respect to the housing along the central axis, the plug incorporating a bias with the bias and the plug incorporated as a single unitary member. In alternate embodiments a living hinge is integral with the actuator and the central shaft such that the living hinge, the actuator and the central shaft are incorporated together as a single unitary member. In further novel single unitary central shafts further engagement elements receive a novel single unitary plug incorporating the bias where the plug end advantageously has a central opening or aperture for locking with the engagement elements for advantageously allowing a lollipop to pass therethrough for use with the novel elongated housing in a miniature embodiment of the present invention.

### BRIEF DESCRIPTION OF DRAWINGS

For the purpose of facilitating an understanding of the invention, the accompanying drawings and detailed description illustrate preferred embodiments thereof, from which the invention, its structures, its constructions and operations, its processes, and many related advantages may be readily understood and appreciated.

FIGS. 1A and 1B are exploded views of a prior art confectionery interior, housing and cover components without a candy lollipop, with FIG. 1A showing the prior art bias spring separate from the plug requiring connection thereto, and the central shaft configured with a centrally disposed opening for connecting with a separate actuator button for the button external to the internal central shaft in the housing, having the actuation button extending separately therefrom as shown in FIG. 1B according to the prior art;

FIGS. 1C and 1D show side views of prior art configured interior components having the housing and the pair of hinged covers assembled for showing prior art components exposed in cross section side views with the separate components of FIGS. 1A and 1B assembled, with FIGS. 1C and 1D respectively illustrating the hinged covers closed with the central shaft retracted, and the covers open with the central shaft extended from the housing to expose the candy lollipop;

FIG. 2A is an exploded view of a novel single unitary central shaft embodiment having a living hinge integral with the actuator and the central shaft, wherein the living hinge, the actuator and the central shaft are incorporated together as a single unitary member while employing separate bias and plug components; FIG. 2B has the integral unitary central shaft element and the living hinge actuator incorporated together as unitary, further its novel single unitary plug as shown incorporates a bias where the bias or spring member and the plug are incorporated as a single unitary member of the present inventions;

FIGS. 3A and 3B show the novel single unitary plug having the bias incorporated with the plug as a single unitary member defining central aperture opening both for locking engagement and allowing a lollipop to pass therethrough in accordance with the present inventions;

FIGS. 4A and 4B and 5A and 5B show the bias for bottom end coupling of the central shaft for movement of the central shaft; FIG. 4C illustrates a bottom plan view of an assembled embodiment of the covered retracted confectionery inner shaft, housing and cover components showing the fixed position of a bottom plug embodiment; FIG. 5B illustrates a bottom plan view of an assembled embodiment of the covered retracted confectionery inner shaft, with the coupling having the plug coupled at the bottom end of the central shaft for movement of the plug with the central shaft in the bottom portion of the housing in accordance with the present invention;

FIGS. 6A, 6B and 6E are respective exploded views of alternate embodiments with novel single unitary central shaft shown for embodiments having a living hinge integral with the actuator and the central shaft; FIGS. 6C and 6D are respective exploded views of the embodiments of FIGS. 2A and 2B employing the novel single unitary central shaft and the novel single unitary plug respectively in accordance with the present inventions;

FIGS. 7A through 7F are respective assembly views of alternative central shaft incorporating a series of bumps or protrusions for receiving and securing the candy lollipop stick therein in accordance with the present inventions.

### DETAILED DESCRIPTION OF THE EMBODIMENTS

The following description is provided to enable those skilled in the art to make and use the described embodiments set forth in the best mode contemplated for carrying out the inventions. Various modifications, equivalents, variations, and alternatives, however, will remain readily apparent to those skilled in the art. It is noted that throughout this detailed description, words such as “front” and “rear,” “forward” and “rearward,” “top” and “bottom,” and “upper” and “lower,” as well as similar positional or locational terms; it is intended that all such additional structures, methods, features and advantages are within the scope of the inventions defined by the claims. Nothing should be taken as limitations of the descriptions herein. Further aspects and advantages are discussed below.

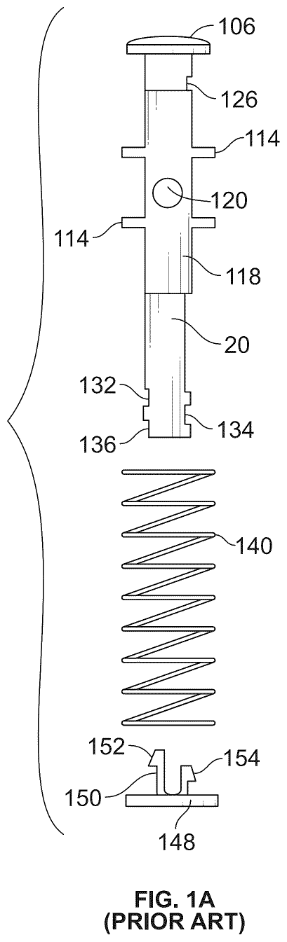

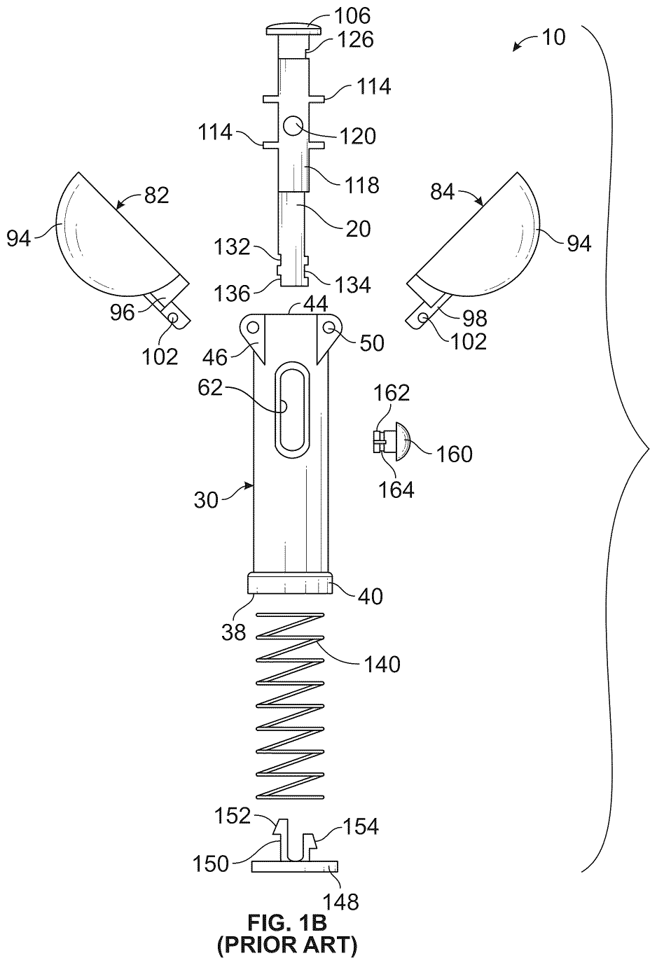

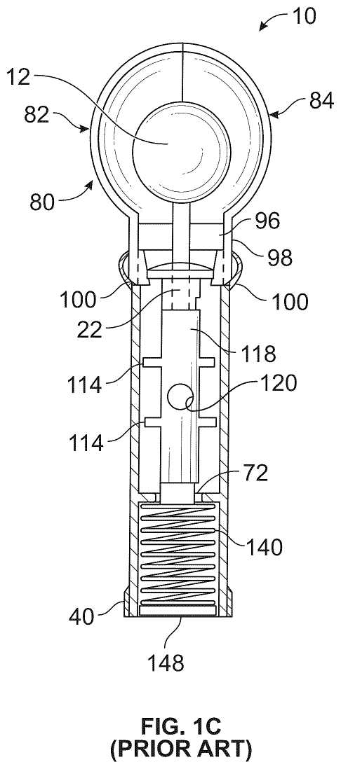

FIGS. 1A and 1B are exploded views of a prior art confectionery interior, housing and cover components without a candy lollipop, with FIG. 1A showing the prior bias spring separate from the plug requiring connection thereto. The covered retracted confectionery 10 providing a topper or head 80 may be conveniently made in the form of a recognizable object such as ball used in a particular sport or as the head of a character with eyes, nose and mouth in relief. The disclosure of Applicant's Assignee's U.S. Pat. No. 8,524,300 is herein incorporated by reference in its entirety. With reference to prior art FIGS. 1A-1D the covered retracted confectionery 10 with cover 80 is pivotally or hingedly mounted atop hand-holdable outer housing 30 in accordance with FIG. 1B for movement between the closed position illustrated in FIG. 1C and the open position illustrated in FIG. 1D.

FIGS. 1C and 1D show side views of prior art configured interior components having the housing and the pair of hinged covers assembled for showing prior art components exposed in cross section side views with the separate components of FIGS. 1A and 1B assembled, with FIGS. 1C and 1D respectively illustrating the hinged covers closed with the central shaft retracted. The outer housing 30 includes a top 44 and an opposing bottom enlarged of housing 30. A hole 50 extends through each of two pairs of integrally molded tangentially extending spaced apart leafs, each pair of opposed pins 102 is received in a corresponding one of holes 50 in a leaf 46 to form a hinge and pivotally mount mating front and back halves 82 and 84 of cover 80 of housing 30 from substantially hemi-spherical portion 94, depending neck 96, and generally centrally disposed tang 98, with housing 30 generally upright or vertical such that each of cover halves 82 and 84 will drop down into the open position of FIG. 1D.

A separate coil spring 140 has an inner diameter larger than the outer diameter of separate shaft 20 so the separate shaft 20 may freely move inside the separate coil spring 140. As shown in the drawings coil spring 140 is of a convention design having a constant inner diameter and a constant outer diameter. However, as the upper coil is larger than opening 72, coil spring 140 will abut the underside of wall 70 and be kept below wall 70. The coil spring 140 may be otherwise be of any appropriate size and suitable material to overcome the force of gravity keeping cover halves 82 and 84 open in its expanded position shown in FIG. 1C as it is not so strong as to preclude a user such as a small child from readily compressing it to the position shown in FIG. 1D. A separate bottom plug 148 having an integrally molded upwardly projecting bifurcated barbed peg 150 fits into bottom 38 of housing 30 and abuts the lower coils of spring 140. Adjacent its bottom 38, the outer housing 30 has an enlarged rim 40 to serve as a base and facilitate standing it upright. Plug 148, more particularly peg 150, is secured on bottom of shaft 20. Bifurcated peg 150 is compressed upon its insertion into bottom until barbs 152 and 154 expand into openings 132 and 134, respectively, to lock bottom plug 148 onto bottom of shaft 20. Staggering the respective height of barbs 152 and 154 rather than having them aligned facilitates assembly in cooperation with the openings in shaft 20 and causes a one-time snap locking plug 148 in shaft 20 to occur only if assembled correctly to ensure there is no small part safety issue.

In operation the user manually pushes actuator button 160 upwardly, moving shaft 20 and top 24 of disc 106, candy lollipop 12 with bottom plug 148 upwardly inside housing 30. The actuator button 160 has a bifurcated stem 162 with a circumferential slot 164 is inserted though oblong slot 62 of housing 30 and secured in a substantially central opening 120 on elongated plate 118 with guide ribs 114 and openings 126, 132, 134 and 136. As disc 106 moves upwardly away from its abutment with tabs 100 hinged cover halves 82 and 84 allowing them to drop open from the force of gravity, exposing the candy lollipop 12 at its stem 14 from bore 22 is exposed for consumption. The upward movement of bottom plug 148 compresses coil spring 140. Accordingly, when actuator 160 is released, the bias of compressed coil spring 140 will automatically retract shaft 20 with candy lollipop 12, and at the same time move disc 106 back down into contact with tabs 100 and cause cover halves 82 and 84 to pivot back up to the closed position. Adjacent its top 44, housing 30 has two pairs of integrally molded tangentially extending spaced apart leafs 46. More particularly, one pair of leafs 46 extends tangentially out from the front and back of each semi-cylindrical portion 32 and 34 adjacent top 44, each leaf 46 has a support branch 48 projecting generally perpendicular to the leaf toward the flat edge of the semi-cylindrical portion. A hole 50 extends through each leaf 46.

When semi-cylindrical portions 32 and 34 are secured together, holes 50 of each of the opposed front leafs are generally axially aligned with each other and holes 50 of each of the opposed back leafs are generally axially aligned with each other. Also, as is perhaps best illustrated in FIGS. 1A-1D, when portions 32 and 34 are secured together a notch 154 extending down from top 44 to branches 48 is formed between each opposed leaf 46 as a result of the corners being eliminated from between each leaf 46 and the flat edge of the semi-cylindrical portion, and from each branch 48 to top 44. In addition, a short, narrow slot 58 depends below each set of opposed branches 48. Intermediate bottom 38 and top 44, closer to top 44 as illustrated in the drawings, one side, more particularly left portion 34 is formed with an oblong closed slot 62 surrounded by a recess 64. Inside of housing 30, more proximate bottom 38 than top 44, formed of substantially perpendicularly inwardly projecting shelves 68, is interior wall 70 with a generally centrally disposed opening 72.

Mounted on top of housing 30 is cover 80 formed of mating front half 82 and back half 84 molded of plastic like materials such as ABS. Cover, topper or head 80 may also be conveniently made in the form of a recognizable object such as ball used in a particular sport or as the head of some character. Indeed, housing 30 may be made in a complementary form, such as a baseball bat for a baseball topper, or the body of a character to match the head, with two dimensional eyes 86, a three-dimensional nose 88, and a two-dimensional mouth 90. Each cover half has a substantially hemi-spherical portion 94 with a depending neck 96 and a further depending, generally centrally disposed tang 98. Projecting inwardly toward housing 30 from adjacent the bottom of tang 98 is a tab 100 and projecting out sideways from adjacent the bottom of tang 98 are a pair of opposed pins 102. The interiors of hemi-spherical portions 94 are conveniently sized so lollipop 12, or whatever other confectionery they are designed for, does not encounter the plastic when cover 80 is closed.

On top 24 of shaft 20 is a dome shaped circular disc 106 having a larger diameter than shaft 20, the underside of disc 106 abuts tab 100 of each cover half 82 and 84 to restrain them in the closed position. Flanges are provided with each of the covers having the lower tab projecting inwardly toward the center of the housing, each pair of opposed pins 102 is received in a corresponding one of holes 50 in a leaf 46 to form a hinge and pivotally mount mating front and back halves 82 and 84 of cover 80 between right and left portions 32 and 34 of housing 30. Slot 58 facilitates assembly of the housing 30 and cover halves 82 and 84 as it provides give or flex when inserting hinge pins 102 in holes 50. Shaft 20, which may be molded of a plastic such as polypropylene, has a generally hollow interior below disc 106 down to bottom 110 of shaft 20. Extending substantially radially outward are integrally molded guide ribs of a diameter larger than shaft 20 and less than interior 36 of housing 30. Shaft 20 also has openings 126, 128, 130, 132, 134 and 136 needed to core out molded shaft 20 based on the direction the manufacturing tool needs to come from to accomplish creating a hole for the lollipop stem and create slots for locking in a bottom plug.

Bottom 110, as well as the lower portion of shaft 20 up to plate 118, readily fits and is supported for reciprocating movement substantially along the axis of housing 30 in opening 72 of wall 70. As is shown in the drawings, the portion of shaft 20 having openings 132, 134 and 136, is disposed below wall 70 in both the open and closed positions of covered retracted confectionery 10. Surrounding the lower portion of shaft 20 below wall 70 is a coil spring 140. Springs 140 and 214 have inner diameters larger than the outer diameter of described shafts 20, 200, 202, 204, 206 so the shaft may freely move inside the spring and its outer diameter is smaller than interior 36 of housing 30. As shown in the drawings coil spring 140 is of a convention design having a constant inner diameter and a constant outer diameter. However, with the upper coil is larger than opening 72, spring 140 will abut the underside of wall 70 and be kept below wall 70. Spring 140 may be otherwise of any appropriate size and suitable material to overcome the force of gravity keeping cover halves 82 and 84 open in its expanded position. The bottom plug 148 having an integrally molded upwardly projecting bifurcated barbed peg 150 fits into bottom 38 of housing 30 and abuts the lower coils of spring 140. Plug 148, more particularly peg 150, is secured on bottom 110 of shaft 20. Bifurcated peg 150 is compressed upon its insertion into bottom 110 until barbs 152 and 154 expand into openings 132 and 134, respectively, to lock bottom plug 148 onto bottom 110 of shaft 20. Staggering the respective height of barbs 152 and 154 rather than having them aligned facilitates assembly in cooperation with the openings in shaft 20 and causes a one-time snap locking plug 148 in shaft 20 to occur only if assembled correctly to ensure there is no small part safety issue.

An actuator button 160 having a bifurcated stem 162 with a circumferential slot 164 is inserted though oblong slot 62 of housing 30 and secured in aperture 120 with plate 118 frictionally engaging slot 164. Stem 162 is received for sliding reciprocating movement in oblong slot 62 with actuator button 160 moveable generally vertically along the outside of housing 30 as shown in the drawings. In operation the user manually pushes actuator button 160 upwardly, moving shaft 20 including disc 106, lollipop 12, and bottom plug 148 upwardly inside housing 30. As disc 106 moves upwardly away from its abutment with tabs 100 of hinged cover halves 82 and 84 allowing them to drop open from the force of gravity, lollipop 12 is exposed for consumption. At the same time, the upward movement of bottom plug 148 compresses spring 140. Accordingly, when actuator 160 is released, the bias of compressed spring 140 will automatically retract shaft 20 with lollipop 12, and at the same time move disc 106 back down into contact with tabs 100 and cause cover halves 82 and 84 to pivot back up to the closed position.

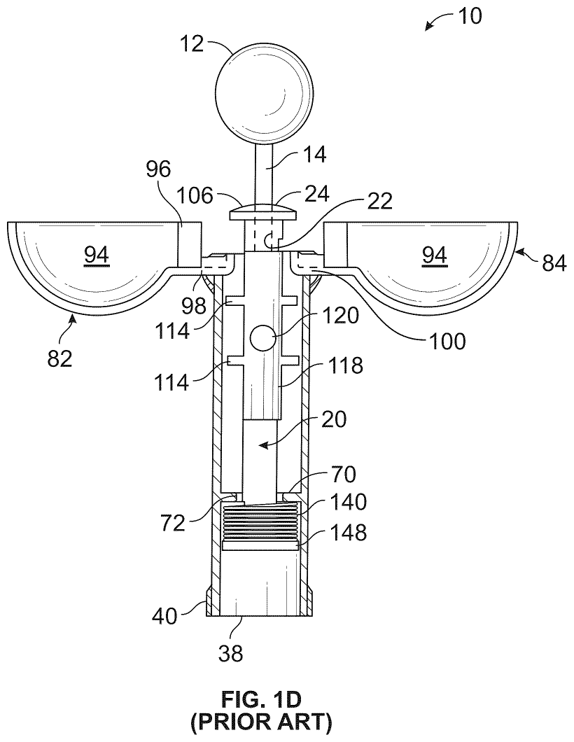

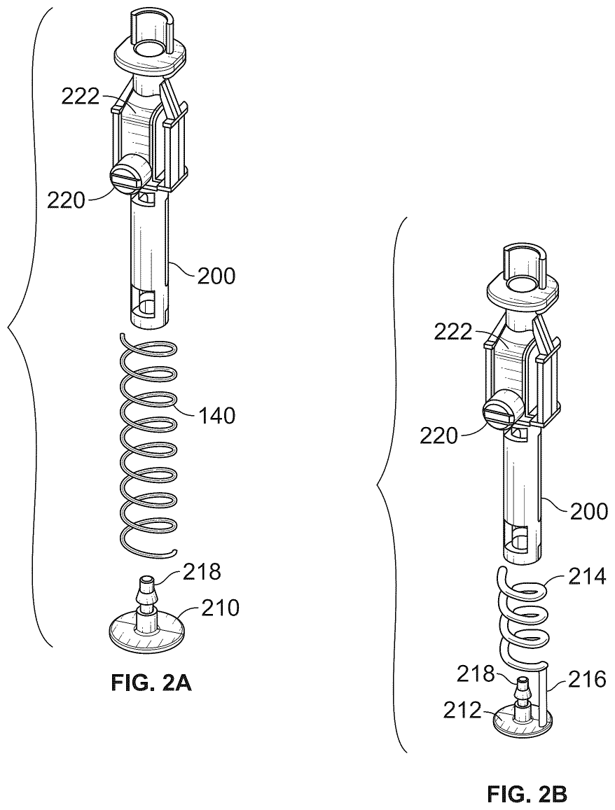

The present described embodiments relate to covered retracted confectionery apparatus and methods in an elongated housing with a central shaft, actuator, hinged covers for enclosing the confectionary including a plug or lower element received at the bottom portion of the housing and disposed along the central axis, being coupled at the bottom end of the central shaft for movement of the lower end with the central shaft with respect to the housing along the central axis, the lower end or plug incorporating a bias with the bias and the plug incorporated as a single unitary member. The embodiments of FIGS. 2A and 2B employ a novel single unitary central shaft 200 and the novel single unitary assembly 212 respectively.

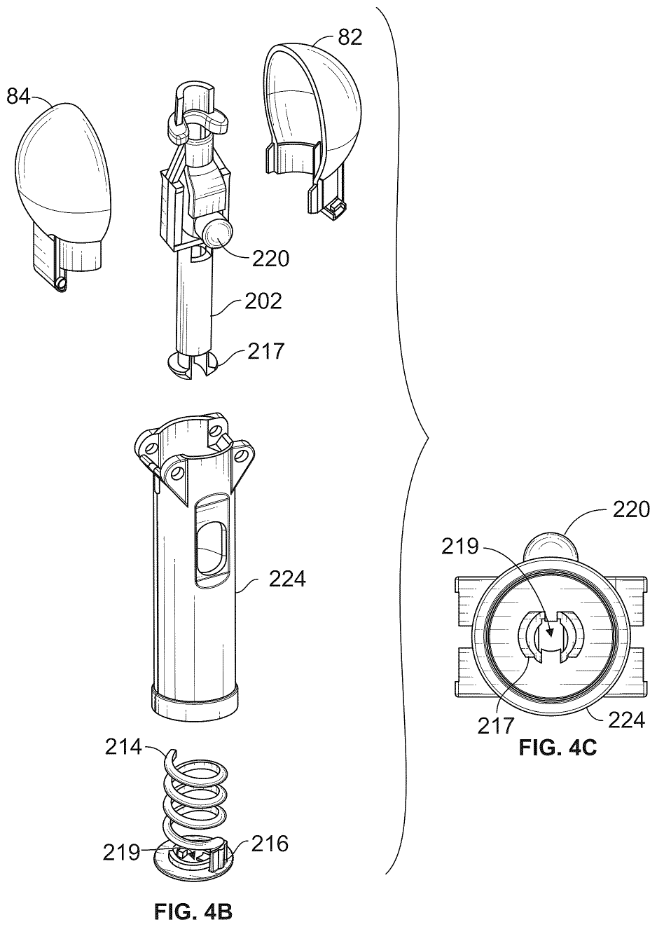

FIG. 2A is an exploded view of a novel single unitary central shaft embodiment having a living hinge integral with the actuator and the central shaft, wherein the living hinge, the actuator and the central shaft are incorporated together as a single unitary member while employing separate bias and plug components; FIG. 2B is an exploded view of another novel single unitary central shaft using the living hinge actuator incorporated together as unitary, and further employing a novel single unitary plug also shown in perspective incorporating a bias with the bias or spring member and the plug incorporated as a single unitary member of the present embodiment; FIG. 4A is an exploded view of a further novel single unitary central shaft of the embodiments with further engagement elements 217 for receiving a further novel single unitary assembly incorporating the bias where the end advantageously has a central opening or aperture 219 for locking with the engagement elements 217 for advantageously allowing a lollipop to pass therethrough.

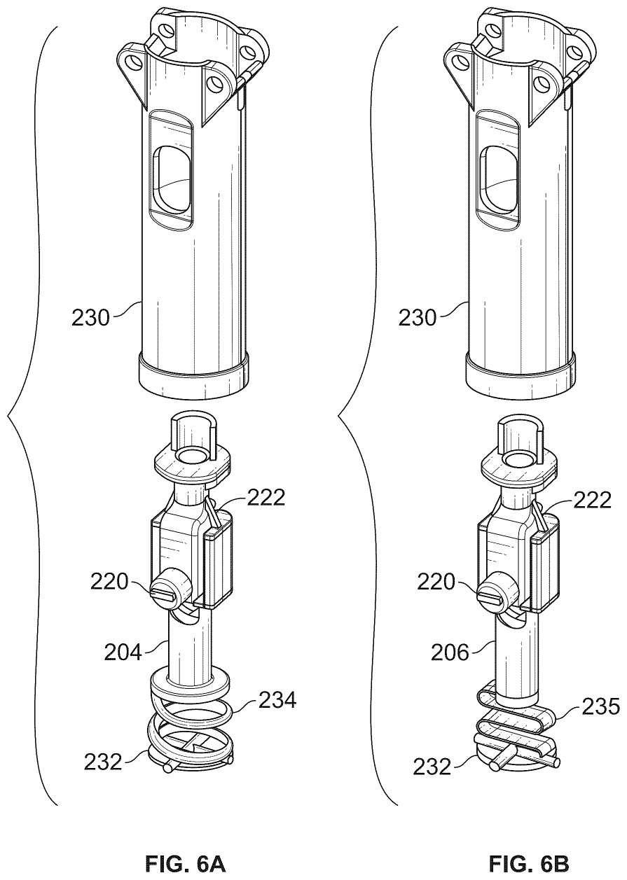

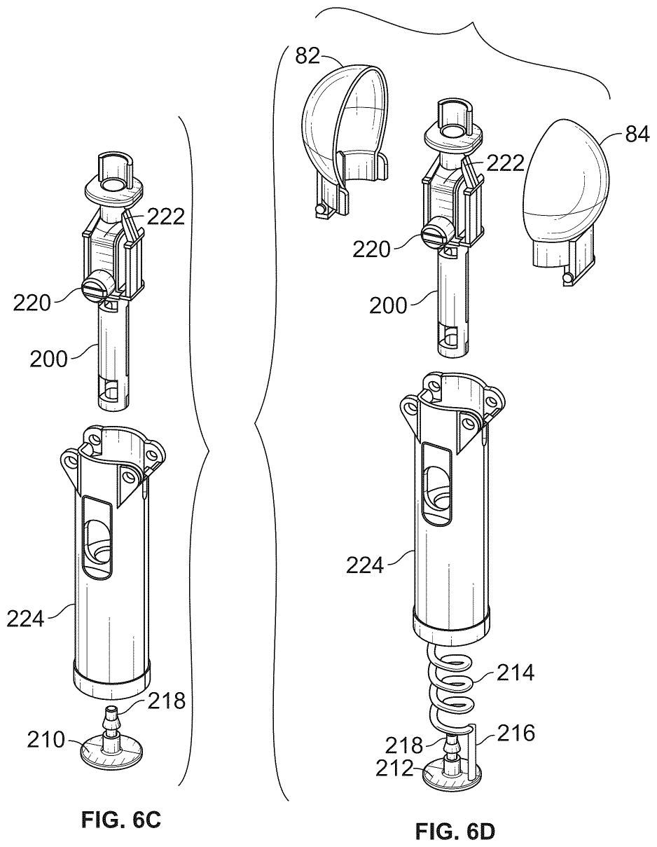

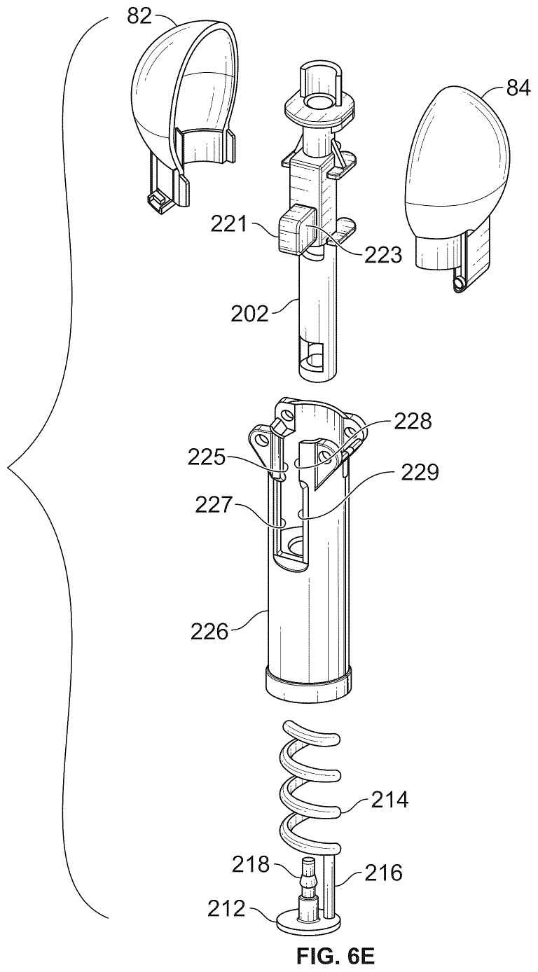

FIGS. 6A, 6B and 6E embodiments show some of the novel integrally formed actuator embodiments directly to its single unitary central shaft 202 for use in its elongated housing 226 embodiment with the complementary slotted end opening 228 at the top end of elongated housing 226 for receiving the actuator 220, 221. Actuator 221 has one or more side walls 223. The complementary slotted end opening 228 of the elongated housing 226 embodiment at the top end thereof includes one or more sides at 225 with opening 228. Below opening 228 a widened rectangular area extends with two or more sides 227 and 229 thereof in which actuator 221 is received during assembly. Having the actuator 221 as a solid part of its single unitary central shaft 202, an angled side discussed below at side 223 of the actuator 221 will spread open the complementary slotted end opening 228 at the top end of elongated housing 226 when receiving the actuator 221 therein during assembly, further locking the actuator 221 with the elongated housing 226 discussed herein.

FIGS. 2A-2B, 4A-4B, 5B and FIGS. 6A-6E are views including alternate central shaft embodiments incorporating together and include an integral bias coupled at the bottom end of the central shaft incorporated as a single unitary member, the housing receiving the actuator incorporated central shaft as a single unitary member of alternate configured embodiments for receiving a novel single unitary central shaft integrated actuator button, confectionery described.

FIG. 2A is an exploded view of the novel single unitary central shaft 200 in perspective of an embodiment having a living hinge 222 integral with an actuator 220 and the central shaft 200, wherein the living hinge 222, the actuator 220 and the central shaft 200 are incorporated together as a single unitary member of the embodiment, however employing separate bias 140 and plug 210 components. In the embodiment of FIG. 2A the plug 210 component is coupled at the lower end of the central shaft 200 at a shaft locking connector 218 for connection therewith. In alternate embodiments as disclosed and illustrated below, the living hinge 222 is integral with the actuator 220 with various other central shaft configurations as discussed further below such that the living hinge, the actuator and the central shaft remain incorporated together as a single unitary member. FIG. 2B is an exploded view of the novel single unitary central shaft 200 in an embodiment having the single unitary member, and further employing a novel single unitary plug 212, 214,216, 232 also shown in perspective incorporating a bias 214 with the bias 214 and the plug 212 connected at post 216 as a further single unitary member of the FIG. 2B embodiment.

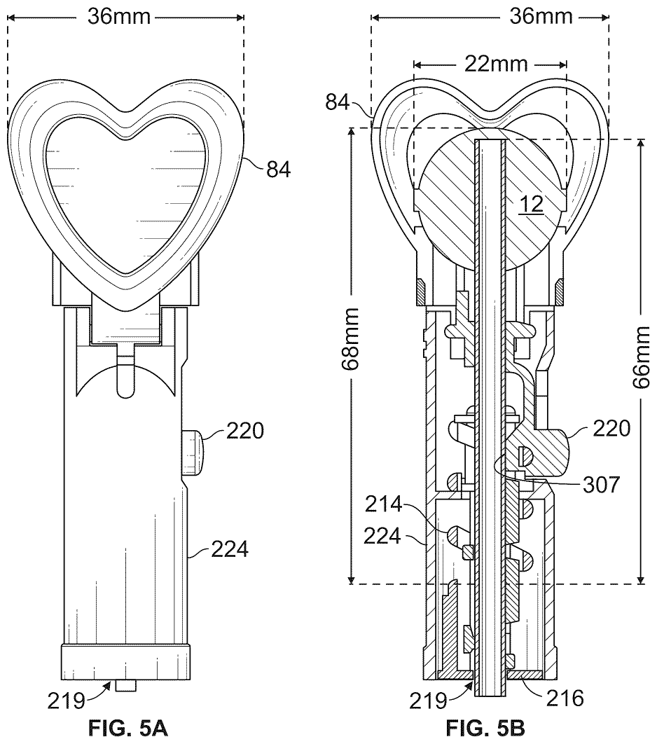

FIG. 4A is an exploded view of a further novel single unitary central shaft of the present inventions with further engagement elements for receiving a further novel single unitary plug incorporating the bias where the plug end advantageously has a central opening or aperture for locking with the engagement elements advantageously allowing a lollipop to pass therethrough. FIG. 4B is an exploded view of a further novel single unitary central shaft of the present inventions and FIGS. 4C, and 5A-5B show the covered retracted confectionery inner shaft, with further engagement elements for receiving a further novel single unitary plug incorporating the bias where the plug end advantageously has a central opening or aperture for locking with the engagement elements accordingly with further engagement elements 217 for receiving further novel single unitary bottom element incorporating the bias where the plug end advantageously has a central opening or aperture 219 for locking with the engagement elements 217 for advantageously allowing a lollipop to pass therethrough.

FIGS. 6C and 6D are respective exploded views of the embodiments of FIGS. 2A and 2B employing the novel single unitary central shaft and the novel single unitary actuator with the central shaft incorporated together as a single unitary member. In such embodiments the plug 212, 214,216, 232, and likewise plug 210, are coupled at the bottom end of the central shaft 200 for movement of the plug 210 or 212 with the central shaft 200 with respect to the housing 224 along the central axis in the bottom portion of housing 224. The elongated housing 224 has its exterior surface centrally defining an open interior with a central axis extending through the interior, defining a top portion and a bottom portion at opposite ends of the central axis. The central shaft 200 has its top end and a bottom end correspondingly disposed along the central axis of the housing 224, with the central shaft 200 mounted for movement between a retracted position and an extended position with respect to the housing 224. The actuator 220 is provided at the exterior surface of the housing 224 for activation. The living hinge 222 may be provided integral with the actuator 220 and the central shaft 200 the forgoing incorporated together. Mechanical activation with the actuator 220 is operable with the central shaft 200. FIG. 6A shows the integral bias as coil spring and FIG. 6B shows the integral bias as wave spring respective embodiments with a novel actuator 221 formed integrally directly to its single unitary central shaft 202 for use with a novel elongated housing 226 embodiment including a complementary slotted end opening 228 at the top end of elongated housing 226 for receiving the actuator 221 with the central shaft 202 incorporated together, with FIGS. 6A and 6B further novel single unitary plug 232 facilitate ease of assembly of respective embodiments, where end opening into the elongated housing 230 for receiving the actuator coupled at the bottom end of the central shaft inner shaft, housing fixed position bottom plug embodiment therein for movement of the plug with the central shaft in the bottom portion of the housing with the bias secured with a locking snap connection affixing the plug at the bottom portion of the housing 230 at snap-in with respect to the housing along its central axis while having the plug affixed at the bottom portion of the housing, and having a locking snap connection affixing the plug at the bottom portion of the housing.

The living hinge 222 being provided integral with the actuator 220 and the central shaft 200 advantageously facilitates ease of manufacture and assembly into the housing 224. Accordingly efficient and reliable retracted confectionery design is achieved with the disclosed integrated componentry for improved manufacture and assembly with fewer separate parts. The actuator 220 may further provide the button as illustrated at the exterior surface of housing 224 for mechanical activation. Again, FIG. 6B is shown in the alternative to employ the central shaft 202 with its incorporated actuator 221, additionally for use with the novel single unitary plug 212 further facilitating ease of assembly. Additionally efficient and reliable retracted confectionery design is achieved with the disclosed integrated componentry for improved manufacture and assembly with fewer separate parts.

The pair of covers 82, 84 are hinged at the top portion of the housing 224, each of the covers 82, 84 in mechanical communication with the central shaft 200 via activation of the actuator 220 for movement of the central shaft 200 for corresponding movement of the covers 82, 84 between a first closed position and a second open position. The confectionery receiving structure is at the top end of the central shaft, the pair of covers for enclosing the confectionary with the covers in the first closed position and revealing the confectionary with the covers in the second open position. The confectionery receiving structure interior may include receiving nipples along an inner shaft for the purpose of holding the lollipop stick securely from falling out no matter what stick diameter or length is inserted.

Integral assembly elements 212, 214, 216, 232 received at the bottom portion of the housing are disposed along the central axis. Bottom element 212, 214, 216, or 232 is coupled at the bottom end of the central shaft 200 for movement with the central shaft 200 with respect to the housing 224 along the central axis. The bias 214, and likewise bias 235 or other related embodiments described herein, may include a singular spring component incorporated integrally with the plug, and selected from a group consisting of plastic, metal, or any flexible material, and the like. The singular spring component may be provided as a coil spring component, wave spring or zigzag component or like bias structures as illustrated. The configuration eliminates the need for a separate metal spring and avoids any release therefrom in the event of breaking off the bottom plug structures.

As a way to provide a structural locking system for the actuator 221 in the rectangular area at the sides 227 and 229 thereof, either or any combination of the one or more side walls 223 of actuator 221, and/or one or more sides 227 or 229 are chosen with extending angled side surfaces at angles to structurally lock the actuator 221 within the rectangular area at the sides 227 and 229. Once assembled the structural locking system for the actuator 221 within the rectangular area further prevents removal of unitary central shaft 202 from its elongated housing 226 from the slotted end opening 228 at the top end of elongated housing 226.

Alternate embodiments with further novel single unitary central shafts 204 and 206 shown respectively for embodiments having the integral living hinge and actuator of the central shaft 204, 206 being received into a further housing 230 as integrated componentry for improved manufacture and assembly with fewer separate parts, where integral bias as wave spring respective embodiments of the described embodiments. Further as integrated componentry with fewer separate parts the bias respectively 234, 235 are connected integrally at the bottom end of the novel central shaft 204 for movement of the bias portion of the integral plug with the central shaft 204 with respect to the housing 230 along the central axis in the bottom portion of the housing. Herein the plug 232 is affixed at the bottom portion of the housing 230, and respectively the bias element is coupled at bottom end of the central shaft 204 for movement of the central shaft 204 with respect to the housing 230 along the central axis.

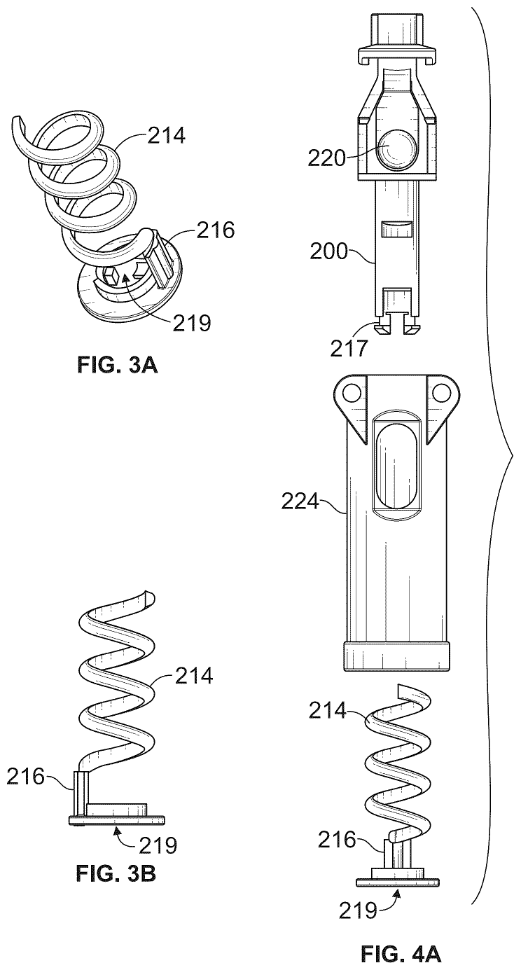

In further alternate embodiments with reference to the novel single unitary plug 212, FIG. 3A illustrates provision of the bias 214 incorporated with the plug 212 as a single unitary member embodiment with coupling of the plug coupled at the bottom end of the central shaft for movement of the plug with the central shaft in the bottom portion of the housing. The novel single unitary plug 212 as shown incorporates bias 214 as the integral spring discussed having the bias 214 with the plug 212 connected at post 216 as a single unitary member for use in various described embodiments herein. The plug 212 with its intermediate opening aperture hole 219 therethrough where the central shaft couples with an engagement element of the central shaft receives the unitary end base at opening aperture 219. The intermediate hole aperture both locks engagement and further accommodates to allow a lollipop to pass through opening aperture hole 219 with respect to the housing along the central lengthwise longitudinal axis in the bottom portion of the housing. The engagement elements 217 receive as a further novel single unitary plug incorporating the bias where the plug end advantageously uses central opening or aperture 219 for locking with the engagement elements 217 and advantageously allowing a lollipop to pass therethrough. The aperture accommodates and allows such confectionery to pass therethrough with respect to the housing along a longitudinal axis of the bottom portion of the housing, with central shaft for movement of the central shaft with respect to the housing along the longitudinal axis.

FIGS. 3A-3B and 4A-4C illustrate the novel single unitary assembly having the bias incorporated with the housing member of the embodiment with a further novel single unitary central shaft of the embodiments with further engagement elements 217 for receiving a further novel single unitary plug incorporating the bias where the plug end advantageously has a central opening or aperture 219 for locking with the engagement elements 217 for advantageously allowing a lollipop to pass therethrough. FIGS. 4A-4C are show with housings views where the plug at the bottom portion of the central shaft affixing of the central shaft for movement with respect to the housing along its central axis with a locking snap connection of FIG. 4C as discussed herein.

FIGS. 2A-2B, 4A-4B, 5B and FIGS. 6A-6E are views including alternate central shaft embodiments incorporating together and include an integral bias coupled at the bottom end of the central shaft incorporated as a single unitary member in accordance with the present invention; where an alternate Miniature housing in a novel embodiment for receiving a novel single unitary central shaft integrated actuator button embodiment for being received in the complementary Miniature elongated housing for receiving the central shaft incorporated together, pivotally mount mating front and back halves of a cover with substantially hemi-spherical portions, with integrated actuator button single unitary central shaft embodiment further employing the complementary miniature housing for receiving the actuator button of the incorporated central shaft as a single unitary member of alternate configured embodiments for receiving a novel single unitary central shaft integrated actuator button, confectionery inner shaft in accordance with the embodiments.

With reference to the alternate miniature housing of FIGS. 4A-4B, and 5A-5B are respective views of an alternate Miniature housing in a novel embodiment for receiving a novel single unitary central shaft integrated actuator button embodiment for being received in the complementary Miniature elongated housing for receiving the actuator button of the central shaft incorporated together, pivotally mount mating front and back halves of a cover with substantially hemi-spherical portions, employing the novel single unitary plug incorporating the bias spring and plug incorporated therein as a single unitary member. The novel embodiment for receiving a novel single unitary central shaft integrated actuator button embodiment for being received in the complementary Miniature elongated housing for receiving the actuator button of the central shaft incorporated together; actuator button 200 inward backside include an integral protrusion A bump feature 307 extends in the shaft channel where protrusion feature 307 is an integral part of the inside wall of the central shaft and disposed inward so as to act as interference force with the inserted lollipop stick designed to force the inserted lollipop stick with frictional interference discussed further below. Pivotally mount mating front and back halves of a cover employ the novel single unitary plug incorporating the bias spring and bottom therein as a single unitary member, with pivotal mount mating front and back halves 82 and 84 of cover 80 of housing 30 from substantially hemi-spherical portions.

The respective integrated actuator button single unitary central shaft embodiments employ the novel single unitary spring as discussed and shown incorporating the bias, with the bias or spring member incorporated as a single unitary assembly of the embodiment; FIG. 4B is an exploded view of a further novel single unitary central shaft of the embodiments with further engagement elements 217 for receiving a further novel single unitary plug incorporating the bias where the end advantageously has a central opening or aperture 219 for locking with the engagement elements 217 for advantageously allowing a lollipop to pass therethrough for use with the novel elongated housing in a miniature embodiment unique and uncommon in the market. The button spring/plug design has been created to remove the metal spring, thus saving the cost of the spring plus the cost of inserting the metal spring.

With reference to FIGS. 3A through 3B, and particularly FIGS. 4A through 4C respective views show complementary miniature housing for receiving the actuator button of the incorporated central shaft as a single unitary member of an alternate elongated housing in a novel opening embodiment for receiving a novel single unitary central shaft integrated actuator button embodiment for being received in the complementary key-hole opening end in the elongated housing for receiving the actuator button of the central shaft incorporated together, with FIGS. 3A-4C further employing the novel single unitary plug incorporating the bias spring incorporated therewith as a novel unitary bias member with the plug as a single unitary member defining central aperture opening both for locking engagement and allowing a lollipop to pass therethrough.

The respective exploded assemblies of the embodiments described employ the single unitary central shaft with further engagement elements 217 for receiving a further novel single unitary plug incorporating the bias where the plug end advantageously has a central opening or aperture 219 for locking with the engagement elements 217 for advantageously allowing a lollipop to pass therethrough, and FIGS. 5A-5B show the covered retracted confectionery inner shaft, showing respective front and pivotally mounted Heart shaped mating cover front and back halves of FIGS. 5A-5B substantially Heart shapes, using the novel single unitary plug incorporating a bias with the bias and the plug incorporated housing and cover components assembled of illustrated FIG. 5B embodiments using the novel single unitary plug incorporating a bias with the bias and the plug incorporated as a single unitary member. An alternate elongated housing with a key-hole opening embodiment may provide a further opening aperture receiving a corresponding novel single unitary central shaft integrated actuator button embodiment for being received in the complementary key-hole opening end in the elongated housing. The key-hole opening aperture receives a corresponding novel single unitary central shaft integrated actuator button embodiment for being received in the complementary key-hole opening end in the elongated housing. The key-hole opening accommodates a novel complementary button actuator of an alternate shaft designed to remove the shaft mold manufacture side action during its molding process to increase the output by decreasing the cycle time, which also reduces tooling cost and molding cost. In assembly the actuator button of the central shaft is received together employing the novel single unitary plug incorporating the bias spring and plug incorporated therein as a single unitary member discussed above, with further reduced parts count down to three total parts. Moreover, mold tools are advantageous with an eight (8) cavity molding process. The risk of small button actuators popping off during usage is further eliminated with slide button now being molded to the inner shaft. The respective views of the integrated actuator button single unitary central shaft embodiment unitary plug incorporating a bias with the bias and the plug incorporated as a single unitary member, as discussed. The button can still be pressed inward when in the up position on the tube, however, once the stick of the lollipop had been inserted into the shaft, the button cannot be pressed inward due to a small rib of plastic on the underside of the button area, that presses into the lollipop stick thus keeping the button extended outward when in the up position. The button spring/plug design has been created to remove the metal spring, thus saving the cost of the spring plus the cost of inserting the metal spring. By combining the spring to the existing bottom plug a resulting novel design is achieved as unique and uncommon in the market.

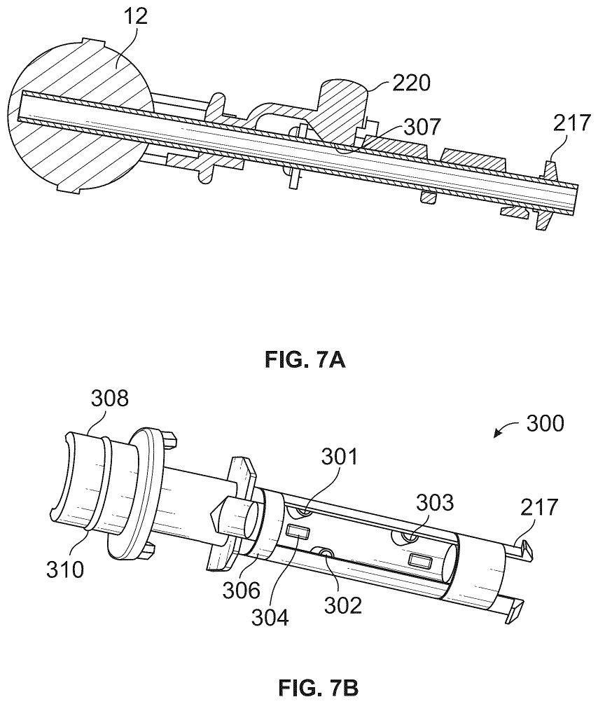

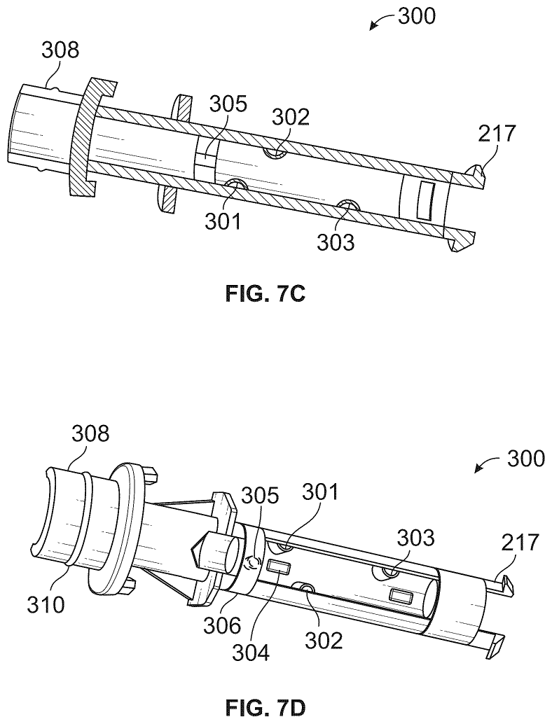

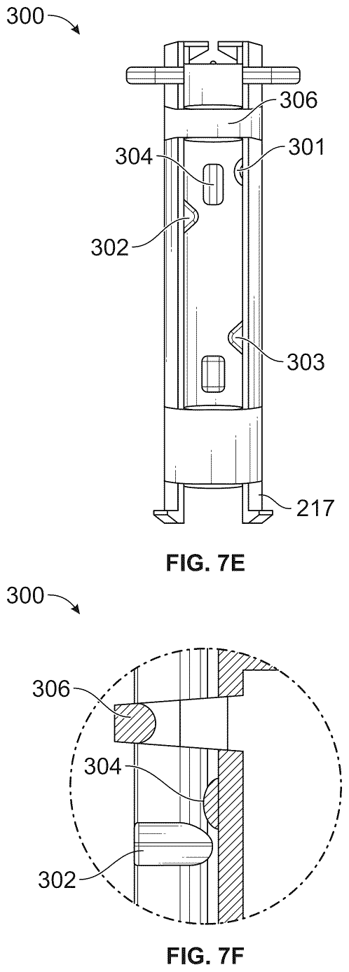

FIGS. 7A through 7F are alternative central shafts incorporating a series of bumps or protrusions for receiving and securing the candy lollipop stick therein in accordance with the respective embodiments with alternative central shaft 300 incorporating a series of bumps or protrusions 301, 302, 303, 304, 305 described below for receiving and securing various differing sized candy 12 lollipop sticks therein in accordance with being received within the upper lip collar portion 308 of the central shaft 300 for stick assembly insertion, receipt, and twist with its candy wrapper for closure. Bumps 304 and 305 top/bottom or front rear; combination of bumps design to hold a multiplicity of variety of sticks, now in more dimensions, protrusions 301, 302, 303 are disposed perpendicular to 304, 305 (303 may not be reached or used with shorter sticks) because there are several variables on lollipop sticks, (moreover presently paper sticks considered not good bacterially, so then plastic sticks but various sizes.) On the small diameter lollipop stick this bump acts as interference, working in conjunction with the other 4 or less Bumps, depending on the length of the stick, and the Ring, and will anchor the lollipop stick in place when inserted.

Bump Feature 301 is an integral part of the inside wall of the Shaft channel and is half-round in shape. Bump Feature 302 is an integral part of the inside wall of the Shaft channel, and is more Tear-Drop in shape with a ramp curve at the top. This shape helps guide the lollipop stick through the channel, while acting as interference by forcing the inserted lollipop stick to the opposite side. These are designed to force the inserted lollipop stick to one side to cause interference. Bump 305 is disposed under the “ring” 306 feature of the Shaft 300. On the small diameter lollipop stick, with a diameter of 0.125″ the underside of this Ring acts as an abutment as Feature 304 interferes with the insertion of this small diameter lollipop stick. Ring structure 306 is a half-round Ring that is an integral part of the Shaft 300 and formed by a core from the opposite side of the Shaft 300 as a feature to stabilize the lollipop stick within the shaft configuration, with a secondary function that the underside of the Ring 306 also functions as an abutment for securing various size lollipop sticks. The bump feature 307 inward also secured the lollipop stick. The described series of bumps or protrusions structures on Shaft component 300 are thus designed to hold the various size lollipop stick without curving the stick to a point that interferes with the operation of the opening operational mechanisms. This advantageously solves securement problems, while still holds the various size lollipop sticks. On the large diameter stick, with a diameter of 0.153″, the underside of this Ring 306 acts as an abutment as Feature 304 more aggressively interferes with the insertion of the large diameter lollipop stick. In this case, more pressure is required to insert this large diameter stick, and the tip area of the stick will flex upward when it is positioned into place. Bump Feature 303 is an integral part of the inside wall of the Shaft channel, which also may be Tear-Drop in shape with a ramp curve at the top. This shape helps guide the lollipop stick through the channel, while acting as interference by forcing the inserted lollipop stick to the opposite side. Bump Feature 304 is an integral part of the inside bottom wall of the Shaft channel, and is half-round in shape, which feature is designed to work in conjunction with the Ring Feature by forcing the inserted lollipop stick upward to wedge against the underside of the Ring. Its half-round shape acts as a ramp to the inserted lollipop stick.

The forgoing methods described for the covered retracted confectionery include providing an exterior surface centrally defining an open interior with a central axis extending through the interior of an housing, the housing defining a top portion and a bottom portion at opposite ends of the central axis, and disposing a central shaft correspondingly along the central axis of the housing, the central shaft having a top end and a bottom end and being mounted for movement between a retracted position and an extended position with respect to the housing. The actuating structure is provided for activation anywhere along or at the exterior surface of the housing, facilitated with hinging a pair of covers at the top portion of the housing for the activation responsive to the actuating structure, each of the covers in mechanical communication with the central shaft via the activation for movement of the central shaft with corresponding movement of the covers between a first closed position and a second open position. The confectioneries such as hard candy, lollipop or other stick candy is received at structure at the top end of the central shaft, with the pair of covers for enclosing the confectionary with the covers in the first closed position and revealing the confectionary with the covers in the second open position. Operation is facilitated generally through receiving the bottom portion of the housing in various described embodiments disposed along the central axis. The bias end thereof may be coupled at the bottom end of the central shaft for movement of the plug with the central shaft with respect to the housing along the central axis. The bottom element and/or plug has its bias incorporated therewith as a single unitary member with the bias as a spring component incorporated integrally.

While embodiments of the inventions have been shown and described with some variations and alternatives, further variations and modifications will occur to those skilled in the art. It is intended in the appended claims to cover all such variations and modifications that come within the true spirit and scope of the present invention. Therefore, the aim is to cover all such changes and modifications as fall within the true spirit and scope of the invention. The matters set forth in the foregoing description and accompanying drawings are offered by way of illustrations only and not as limitations. The actual scope of the invention is to be defined by the subsequent claims when viewed in their proper perspective based on the prior art.

What is claimed is:

1. A covered retracted confectionery apparatus comprising:
an elongated housing having an exterior surface centrally defining an open interior with a central axis extending through the interior, the housing defining a top portion and a bottom portion at opposite ends of the central axis;
a central shaft having a top end and a bottom end correspondingly being disposed along the central axis of the housing, the central shaft mounted for movement between a retracted position and an extended position with respect to the housing;
an actuator at the exterior surface of the housing for activation;
a pair of covers hinged at the top portion of the housing, each of the covers in mechanical communication with the central shaft via activation of the actuator for movement of the central shaft with corresponding movement of the covers between a first closed position and a second open position;
a confectionery receiving structure at the top end of the central shaft, the pair of covers for enclosing the confectionary with the covers in the first closed position and revealing the confectionary with the covers in the second open position; and
a plug received at the bottom portion of the housing and disposed along the central axis, the plug being coupled at the bottom end of the central shaft for movement of the plug with the central shaft with respect to the housing along the central axis, the plug incorporating a bias with the bias and the plug incorporated as a single unitary member.

2. A covered retracted confectionery apparatus as recited in claim 1, further comprising a living hinge integral with the actuator and the central shaft, wherein the living hinge, the actuator and the central shaft are incorporated together as a single unitary member.

3. A covered retracted confectionery apparatus as recited in claim 1, wherein actuator further comprises a button at the exterior surface of the housing for mechanical activation.

4. A covered retracted confectionery apparatus as recited in claim 3, wherein the mechanical activation with the button is operable with the central shaft.

5. A covered retracted confectionery apparatus as recited in claim 1, further comprising a living hinge integral with the actuator and the central shaft, wherein the living hinge, the actuator and the central shaft are incorporated together as a single unitary member, and the actuator further comprises a button at the exterior surface of the housing for mechanical activation.

6. A covered retracted confectionery apparatus as recited in claim 1, wherein the bias comprises a singular spring component incorporated integrally with the plug, and selected from a group consisting of plastic, metal, and flexible material.

7. A covered retracted confectionery apparatus as recited in claim 6, wherein the singular spring component comprises a coil spring component.

8. A covered retracted confectionery apparatus as recited in claim 1, wherein the plug defines an intermediate aperture therethrough.

9. A covered retracted confectionery apparatus as recited in claim 8, wherein the central shaft comprises an engagement element for receiving the plug at the intermediate aperture for locking engagement therewith, said aperture accommodating confectionery to pass therethrough with respect to the housing along a longitudinal axis of the bottom portion of the housing, with central shaft for movement of the central shaft with respect to the housing along the longitudinal axis.

10. A covered retracted confectionery apparatus as recited in claim 1, wherein the plug defines an intermediate aperture therethrough, wherein said aperture accommodating confectionery to pass therethrough.

11. A covered retracted confectionery apparatus, comprising:
an elongated housing having an exterior surface centrally defining an open interior with a central axis extending through the interior, the housing defining a top portion and a bottom portion at opposite ends of the central axis;
a central shaft having a top end and a bottom end correspondingly being disposed along the central axis of the housing, the central shaft mounted for movement between a retracted position and an extended position with respect to the housing;
an actuator at the exterior surface of the housing for mechanical activation;
a pair of covers hinged at the top portion of the housing, each of the covers in mechanical communication with the central shaft;
a confectionery receiving structure at the top end of the central shaft, the pair of covers for enclosing the confectionary; and
a plug received at the bottom portion of the housing and disposed along the central axis, the plug incorporating a bias with the bias and the plug incorporated as a single unitary member.

12. A covered retracted confectionery apparatus as recited in claim 11, wherein the actuator and the central shaft incorporated together as a single unitary member.

13. A covered retracted confectionery apparatus as recited in claim 12, further comprising a living hinge integral with the actuator and the central shaft, the living hinge, the actuator and the central shaft incorporated as a single unitary member.

14. A covered retracted confectionery apparatus as recited in claim 11, wherein the actuator comprises a button at the exterior surface of the housing operable with the central shaft, thereby moving the central shaft via mechanical activation of the actuator.

15. A covered retracted confectionery apparatus as recited in claim 14, further comprising a living hinge integral with the button and the central shaft, the living hinge, the button and the central shaft incorporated as a single unitary member.

16. A covered retracted confectionery apparatus as recited in claim 11, wherein the pair of covers is operable through mechanical activation of the actuator for movement of the central shaft moving the covers between a first closed position and a second open position.

17. A covered retracted confectionery apparatus as recited in claim 16, wherein the confectionery receiving structure facilitates the pair of covers for enclosing the confectionary with the covers in the first closed position and revealing the confectionary with the covers in the second open position.

18. A covered retracted confectionery apparatus as recited in claim 11, wherein the plug defines an intermediate aperture therethrough.

19. A covered retracted confectionery apparatus as recited in claim 11, wherein the plug defines an intermediate aperture therethrough, wherein said aperture accommodating confectionery to pass therethrough.

20. A covered retracted confectionery method comprising:
providing an exterior surface centrally defining an open interior with a central axis extending through the interior of an housing, the housing defining a top portion and a bottom portion at opposite ends of the central axis;
disposing a central shaft correspondingly along the central axis of the housing, the central shaft having a top end and a bottom end and being mounted for movement between a retracted position and an extended position with respect to the housing;
actuating structure for activation at the exterior surface of the housing;
hinging a pair of covers at the top portion of the housing for the activation responsive to the actuating structure, each of the covers in mechanical communication with the central shaft via the activation for movement of the central shaft with corresponding movement of the covers between a first closed position and a second open position;
receiving a confectionery structure at the top end of the central shaft, the pair of covers for enclosing the confectionary with the covers in the first closed position and revealing the confectionary with the covers in the second open position; and
receiving a plug at the bottom portion of the housing and disposed along the central axis, the plug being coupled at the bottom end of the central shaft for movement of the plug with the central shaft with respect to the housing along the central axis, the plug having a bias and defining an aperture incorporated therewith accommodating the confectionery.
